(19) United States
(12) Patent Application Publication
(10) Pub. No.: US 2019/0163370 A1
(43) Pub. Date: May 30, 2019

(54) DATA REPLICATION BASED ON DATA-DRIVEN RECOVERY OBJECTIVES

(71) Applicant: International Business Machines Corporation, Armonk, NY (US)

(72) Inventors: Ravindra R. Sure, Bangalore (IN); Srikanth Srinivasan, Bangalore (IN); Durgesh, Bangalore (IN)

(21) Appl. No.: 15/824,608

(22) Filed: Nov. 28, 2017

(51) Int. Cl. G06F 3/06; G06F 11/14; G06F 11/07

(52) U.S. Cl. CPC G06F 3/065; G06F 11/1458; G06F 2201/80; G06F 11/1489; G06F 11/1497; G06F 11/0793

(57) ABSTRACT

A data recovery (DR) system where local backup (for example, synchronized snapshotting) is performed based on one or more recovery parameters including at least one of the following recovery data objective (RDO) type and/or recovery data block objective (RDBO) type. A recovery point objective (RPO) type parameter may additionally and concurrently used as an alternative local backup trigger.

### BACKGROUND

The present invention relates generally to the field of data replication, and more particularly to data replication performed for data recovery (DR) purposes.

Computerized data has become critical to the survival of an enterprise. Companies typically have strategies for recovering their data should there be a disaster such as floods or earth quake that destroy the primary data center. One recovery strategy involves replicating the data asynchronously and continually to secondary site(s) that can be used to recover the data if the primary site is destroyed. One version of this recovery strategy only sends modified data (byte range) of the files when they are asynchronously replicated to the secondary site(s). In addition, less expensive fileset level synchronized peer snapshots are taken periodically at the primary site and secondary site(s), so that secondary site(s) can recover to most recent data consistent point by restoring to most recent snapshots of filesets.

The period at which the synchronized peer snapshots should be taken are defined based on, recovery point objective (RPO), which indicate the amount of data loss, which may be measured in time that is acceptable to the customer. Thus, the RPO may indicate an upper bound on the amount of time at which new synchronized peer snapshots should be taken. In this way, when the primary site is destroyed, the secondary site(s) would be restored to most recent data consistent point by restoring to most recent snapshot. The restoration of the secondary to most recent consistent point accounts for recovery time objective (RTO), which indicate an upper bound on the amount of time that may be taken to recover to most recent consistent point.

### SUMMARY

According to an aspect of the present invention, there is a method that performs the following operations (not necessarily in the following order): (i) setting a recovery data objective (RDO) threshold value; (ii) operating a data recovery (DR) system including a first data storage sub-system and a second data storage sub-system, where: (a) the second data storage sub-system is located remotely from the first data storage sub-system, and (b) data from the first data storage sub-system is replicated to the second data storage sub-system; (iii) during the operation of the DR system, determining that the RDO threshold value has been met; and (iv) responsive to the determination that the RDO threshold has been met, performing local backups at the first and second data storage sub-systems.

According to an aspect of the present invention, there is a method that performs the following operations (not necessarily in the following order): (i) setting a recovery data block objective (RDBO) threshold value; (ii) operating a data recovery (DR) system including a first data storage sub-system and a second data storage sub-system, where: (a) the second data storage sub-system is located remotely from the first data storage sub-system, and (b) data from the first data storage sub-system is replicated to the second data storage sub-system; (iii) during the operation of the DR system, determining that the RDBO threshold value has been met; and (iv) responsive to the determination that the RDBO threshold has been met, performing local backups at the first and second data storage sub-systems.

According to an aspect of the present invention, there is a method that performs the following operations (not necessarily in the following order): (i) setting a recovery data objective (RDO) threshold value; (ii) setting a recovery data block objective (RDBO) threshold value; (iii) setting a recovery point objective (RPO) threshold value; (iv) operating a data recovery (DR) system including a first data storage sub-system and a second data storage sub-system, where: (a) the second data storage sub-system is located remotely from the first data storage sub-system, and (b) data from the first data storage sub-system is replicated to the second data storage sub-system; (v) during the operation of the DR system, determining that the RDO threshold value has been met; (vi) responsive to the determination that the RDO threshold has been met, performing local backups at the first and second data storage sub-systems; (vii) during the operation of the DR system, determining that the RPO threshold value has been met; (viii) responsive to the determination that the RPO threshold has been met, performing local backups at the first and second data storage sub-systems; (ix) during the operation of the DR system, determining that the RDBO threshold value has been met; and (x) responsive to the determination that the RDBO threshold has been met, performing local backups at the first and second data storage sub-systems. In these embodiments, the backups (snapshots) will be taken if any one of the three RDO, RDBO or RPO threshold is met. In some of these embodiments, once a snapshot is taken the values of these parameters reset to zero.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a block diagram of a DR system according to an embodiment of the present invention;

FIG. 6 is a flowchart of a second embodiment of a method according to the present invention;

FIG. 7 is a flowchart of a third embodiment of a method according to the present invention; and

FIG. 8 is a flowchart of a fourth embodiment of a method according to the present invention.

### DETAILED DESCRIPTION

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

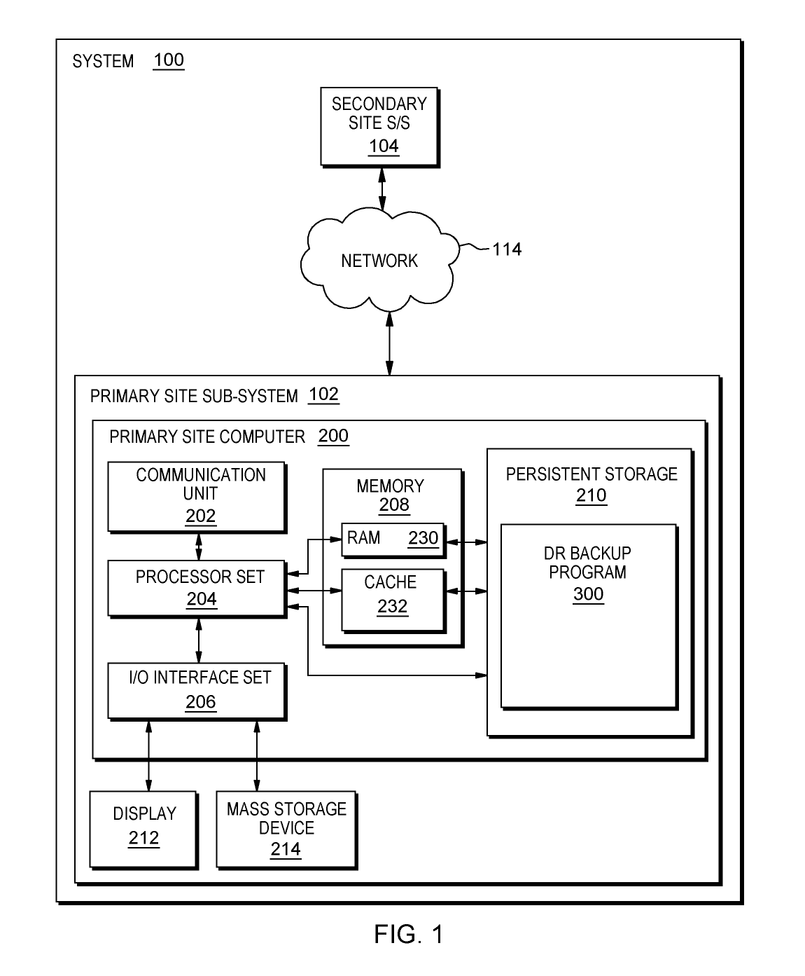

An embodiment of a possible hardware and software environment for software and/or methods according to the present invention will now be described in detail with reference to the Figures. FIG. 1 is a functional block diagram illustrating various portions of data recovery (DR) system 100, including: primary site sub-system 102; secondary site sub-system 104; communication network 114; site computer 200; communication unit 202; processor set 204; input/output (I/O) interface set 206; memory device 208; persistent storage device 210; display device 212; mass storage device 214; random access memory (RAM) devices 230; cache memory device 232; and DR backup program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

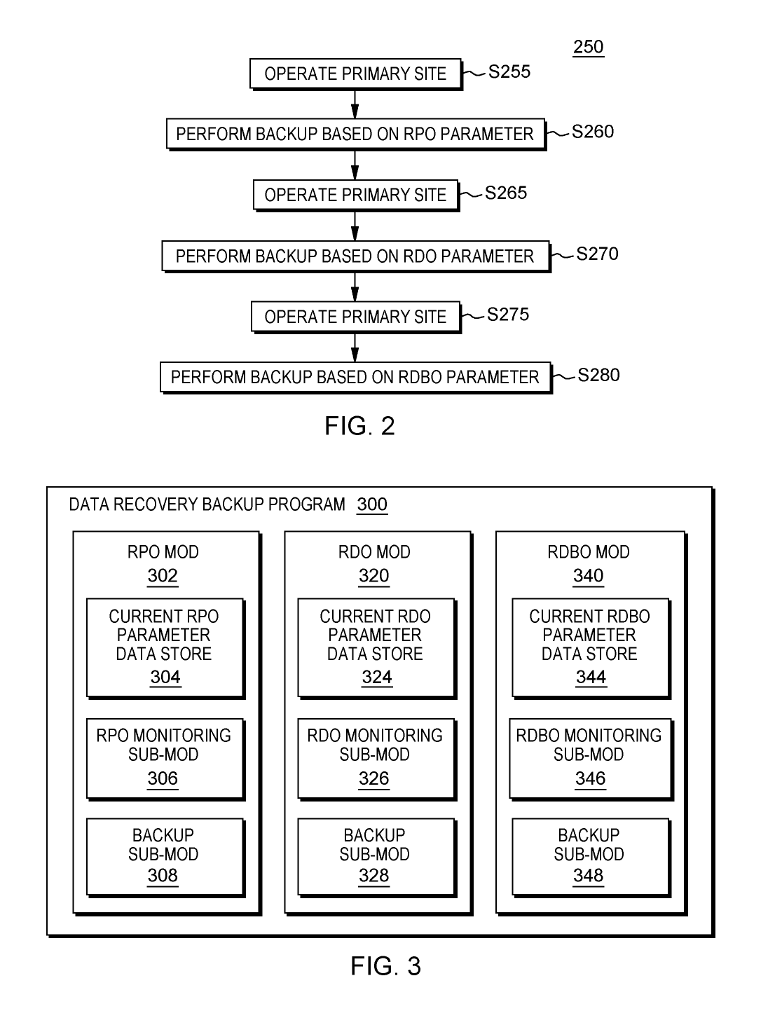

FIG. 2 shows flowchart 250 depicting a method according to the present invention. FIG. 3 shows DR backup program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where primary site sub-system 102 and secondary site sub-system 104 (see FIG. 1) perform normal operations. In this example, this means that: (i) primary site sub-system maintains data in mass storage device 214 (see FIG. 1) by adding, deleting and revising data according to incoming requests received through network 114; and (ii) the data is replicated to the secondary site sub-system so that the data stored at the secondary site sub-system will track the data stored at the primary site (albeit with at least some degree of latency). The frequency and/or synchronicity of this replication in some preferred embodiments is described in more detail in the following sub-section of this Detailed Description section.

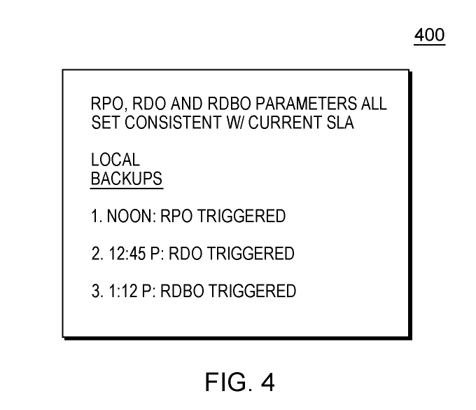

Processing proceeds to operation S260, where local backup is performed at the primary and secondary sites because one of the module (“mods”) 302, 320, 340 has been determined that the data storage operations of operation S260 have caused one of the local data backup parameter values (recovery point objective (RPO), recovery data objective (RDO, or RDBO (recovery data blocks objective) to be met. This embodiment has three parameters that can cause a local backup to be performed: RPO, RDO and RDBO. These three parameters will be further discussed in connection with this current operation S260 (specifically, the RPO parameter) and with the rest of the operation blocks of flowchart 250 (the RDO and the RDBO). In this embodiment, all three of these parameters are monitored concurrently (see screenshot 400 of FIG. 4 at first two lines), so that meeting a threshold value for any of these three operations will cause a local backup operation to occur. Not all embodiments of the present invention must use all three of these parameters. Also, there could be other operative parameters for causing local backup. The RPO parameter is currently conventional (see, Background section, above).

In operation S260, RPO monitoring sub-mod 306 has determined that the recovery point objective (RPO) parameter value (stored in current RPO parameter data store 304) has been met by normal data storage operations of operation S255. This causes backup sub-mod 308 to have local backups performed at the first and secondary site sub-systems (see screenshot 400 of FIG. 4 at fifth line). In this embodiment, the local backups take the particular form of synchronized snapshotting. Synchronized snapshotting will be discussed in more detail in the following sub-section of this Detailed Description section.

Processing proceeds to operation S265, where primary site sub-system 102 and secondary site sub-system 104 (see FIG. 1) continue normal operations during and after the local backups of S260.

Processing proceeds to operation S270, where RDO monitoring sub-mod 326 has determined that the RDO parameter value (stored in current RDO parameter data store 324) has been met by normal data storage operations of operation S265. This causes backup sub-mod 328 to have local backups performed at the first and secondary site sub-systems (see screenshot 400 of FIG. 4 at sixth line).

Processing proceeds to operation S275, where primary site sub-system 102 and secondary site sub-system 104 (see FIG. 1) continue normal operations during and after the local backups of S270.

Processing proceeds to operation S280, where RBDO monitoring sub-mod 346 has determined that the RBDO parameter value (stored in current RBDO parameter data store 344) has been met by normal data storage operations of operation S265. This causes backup sub-mod 348 to have local backups performed at the first and secondary site sub-systems (see screenshot 400 of FIG. 4 at seventh line). While this particular example happened to invoke an RPO based local backup, an RDO based local backup and an RBDO based local backup (in that order), exceeding a threshold with respect to any of these parameters could cause a local backup at any time, so there is no particular order as between intermittent RPO, RDO and/or RDBO based local backups.

### III. Further Comments and/or Embodiments

Some embodiments of the present invention may recognize one, or more, of the following facts, challenges, shortcomings and/or problems with respect to the current state of the art: (i) the RPO defines the amount of data lost measured in time when disaster happen; (ii) even though the time between separate RPO intervals is same the amount of potential data loss is not consistent; (iii) different instance of RPO intervals might have different amount of data updated or modified; (iv) this is a potential problem because it can't be defined how much maximum data can be lost in any RPO interval; (v) the Recovery Time Objective (RTO) is proportional to the data blocks modified from most recent snapshot because all the modified data blocks need to be restored to recent snapshot; (vi) because the amount of data updated is not same between different instances of RPO intervals, the number of data blocks modified are not same; (vii) hence, the RTO will not be consistent; (viii) the RTO can vary even though the RPO interval is same; (ix) this constrains to define accurate RTO during SLA (service level agreement); (x) one efficient method to replicate the data is, where the data is asynchronously and continually replicated to secondary site to recover it later; (xi) this method is optimized method where only modified data (byte range) of the files is asynchronously replicated to secondary site; and/or (xii) in addition, less expensive fileset level synchronized peer snapshots are taken periodically at primary and secondary, so that secondary could recover to most recent data consistent point by restoring to the most recent snapshots of filesets.

Some embodiments of the present invention may include one, or more, of the following characteristics, features, advantages and/or operations: (i) Data-Driven Recovery Objectives RDO and RDBO for estimating consistent RTO accurately with user defined limit on data loss; (ii) provide backup and data replications technologies for disaster recovery; and/or (iii) methods for taking the periodic peer snapshots based on the amount of data modified or added using two new parameters that will respectively be discussed in the following two paragraphs.

One parameter used in some embodiments to control taking the periodic peer snapshots based on the amount of data modified or added is herein referred to as Recovery Data Objective (RDO). When the RDO parameter is used, the amount of data updated or modified can be defined as the “Recovery Data Objective” (RDO), which is the maximum data measured in bytes that can be lost in disaster. As the modified data is replicated asynchronously and continually to secondary site, the size of modified data is accumulated and compared against the value of the RDO defined by the system administrators (for example, an RDO defined in an SLA). As soon as the size of modified, updated or added data reaches the RDO then new synchronized peer snapshots are taken on primary as well as on secondary. This will ensure that the data loss due to disaster at primary site would be maximum close to the RDO value defined.

One parameter used in some embodiments to control taking the periodic peer snapshots based on the number of data blocks modified is herein referred to as Recovery Data Block Objective (RDBO). When the RDBO parameter is used, the number of data or meta-data blocks modified, is defined as the “Recovery Data Block Objective” (RDBO), which is the maximum number of data blocks modified excluding the new data blocks added from most recent snapshot. The RTO is proportional to the time taken to restore modified data blocks to most recent snapshot. In general, when a data block is modified, the old data is copied on-demand to previous snapshot before modifying active file system block called Copy-on-Write. The number of data blocks, which are copied to most recent snapshot is accumulated and compared against RDBO configured. If the number of all the modified blocks exceeds the RDBO limit specified, then synchronized peer snapshots are taken both on primary and secondary sites to ensure that the data blocks modified at any time would not be more than the RDBO value defined.

The Spectrum Scale AFM (active file management) caching technology, where data between two associated sites is kept in sync, implements asynchronous continuous replication of primary file system to secondary file system over WAN. Because the replication operations are asynchronous the network outage does not affect the applications on primary. When remote connectivity is restored to the secondary; all the changes made to primary are replicated to secondary asynchronously. The Spectrum Scale AFM caching technology is enhanced to establish disaster recovery (DR) relationship between two associated sites primary and secondary by adding support for synchronized peer snapshots to create regular periodic consistent peer snapshots on primary and secondary. These periodic peer snapshots are taken at the two sites to establish consistent restore points in case primary hits disaster. These snapshots are taken asynchronously and in-line, so that disaster recovery can use most recent peer snapshot taken at secondary to recover to a consistent point.

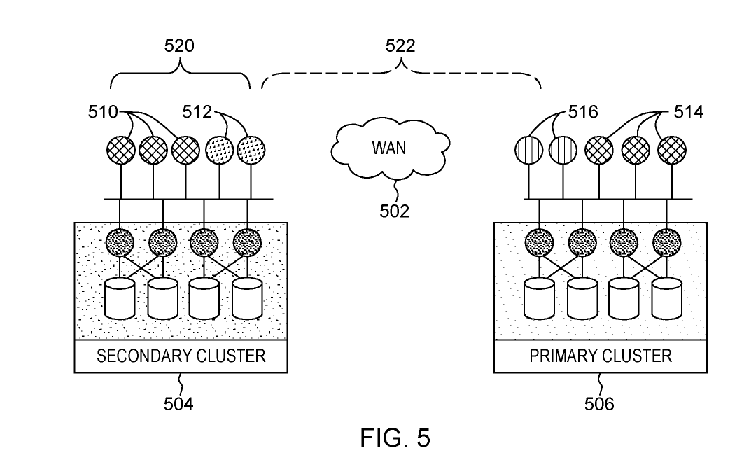

FIG. 5 shows a DR system including: wide area network (WAN) 502; secondary cluster 504; primary cluster 506; secondary compute nodes 510; second I/O (input/output) nodes 512; primary compute nodes 516; primary I/O (input/output) nodes 514; RPC (remote procedure call) message communication path 520; and WAN communication path 522.

As shown in the diagram of FIG. 5, the data recovery (DR, also stands for Disaster Recovery) relationship is established between the primary cluster and the secondary cluster for replicating data to the secondary cluster. The applications write data at primary cluster, which replicates the modified data to the secondary cluster asynchronously and continually. The updates made at the primary cluster are queued up at the gateway (MDS) nodes and asynchronously get replicated to the secondary cluster. Routing all application requests through a subset of nodes (also sometimes referred to as gateways) allows applying various optimization (canceling create/delete, coalescing writes, etc.) based on asynchronous delay before replicating them at the secondary. Maintaining an in-memory queue of pending updates at the gateway nodes allows transient network outages between the replication sites to be masked from application requests. In addition, all file system operations performed at the primary cluster are always replicated in the same order at the secondary cluster to guarantee write ordering and read stability.

The DR relationship between the two sites can be broken causing the secondary to become out-of-date with respect to the primary. Once replication is restarted, a recovery procedure is initiated to bring the secondary cluster up to the date. If the primary cluster experiences a node and/or site failure, the secondary cluster will not have all changes nor do the data reflect any consistent state. For a DR environment, data consistency and integrity is typically required. To provide consistent data replication, regular consistent copies (snapshots) should be taken so that user can restore to a consistent point when needed. In general, the frequency at which the snapshots should be taken are specified by the RPO. But the RPO does not restrict the maximum data would be lost in bytes if the primary cluster is destroyed and the secondary cluster is, in response, restored to a consistent point. The RPO also does not help to accurately estimate the RTO for recovering the secondary cluster to most recent consistent point. To address these two limitations and problems two new specifications are introduced, as mentioned, above. They are Recovery Data Objective (RDO) and Recovery Data Block Objective (RDBO). These two specifications can be used individually or together along with the RPO.

In some embodiments, the implementation of the Recovery Data Objective (RDO) parameter based backup control is performed as follows: (i) the Recovery Data Objective (RDO) is new specification which can be used to define the maximum data measured in bytes that can be lost in disaster; (ii) this ensures that at any time if disaster hits the Primary the data lost should be less or close to the value specified by RDO; (iii) the data modified at Primary is replicated asynchronously and continually to Secondary site; (iv) the gateway nodes maintain the amount of data replicated to Secondary after taking recent peer snapshots; (v) as soon as the size of modified data reaches to the RDO specified then a new synchronized peer snapshots are taken on Primary and Secondary; (vi) due to Asynchronous Delay, the data modified or added at Primary may not be replicated immediately to Secondary; (vii) this will cause lag in taking peer snapshots in real time once data modified reaches to RDO; (viii) a predictive method is used, as described below, to replicate the modified or new data to Secondary once the size of modified or new data is close to RDO specified; (ix) in a clustered file system (like Spectrum Scale) the application would be updating data on multiple application nodes independently in parallel; (x) the update requests are sent to a dedicated node, called Gateway node, designated for each fileset running on Primary site; (xi) a single Gateway node can support multiple filesets for replicating updated data for those filesets from Primary to Secondary asynchronously and continuously as the data gets modified; and (xii) these Gateway nodes maintain separate queues for individual filesets and would maintain the moving average rate of data modified (bytes updated or generated per second by applications) and the bandwidth (bytes sent per second to secondary) for individual filesets.

The gateway node can also be running RDO Snapshot Manager, and it reads the Recovery Data Objective defined as configuration parameter for filesets and maintain size of the data sent to secondary after most recent peer snapshot is taken and monitors the data pending to replicate to the Secondary in the queues for individual filesets. The data needed (D_{N}) to meet the RDO configured value at any time is calculated as follows:

D_{N}=RDO−(Size of data sent after previous snapshot+Data pending in queue)
The average estimated time for generating data needed for meeting RDO value is as follows:
T_{E}=Data needed to meet RDO (D_{N})/Moving average data rate (M_{R})
The time required (T_{R}) to replicated data pending in queue and the data needed to meet next RDO snapshot is calculated as follows:
T_{R}=(Data pending in queue+D_{N})/Average Bandwidth(B_{W})

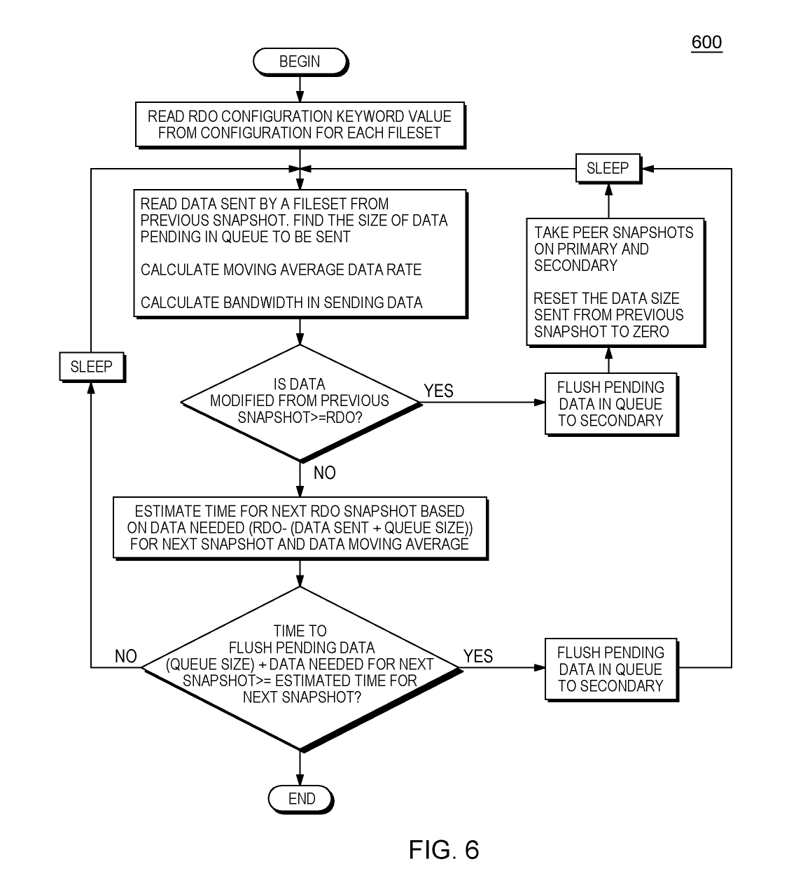

As described in flowchart 600 of FIG. 6, for any fileset at any time, if the time required (T_{R}) to replicate the data pending in queue and the data needed to meet the RDO is close to estimated time(T_{E}) to generate the data needed to meet the RDO then queue will be flushed by over-writing the asynchronous delay. This would ensure that next RDO peer snapshot is taken in close to real time so that data lost due to disaster should be close to specified by RDO.

In some embodiments, the implementation of the Recovery Data Block Objective (RDBO) parameter based backup control is performed as follows: (i) the number of data or meta-data blocks modified, is defined as the “Recovery Data Block Objective” (RDBO), which is the maximum number of data blocks modified excluding the new data blocks added from most recent peer snapshot; (ii) the RTO is proportional to the time taken to restore modified data blocks to most recent peer snapshot; (iii) this new specification RDBO enables to assure consistent RTO during disaster recovery; and (iv) this is desired and valuable feature can be promised during SLA.

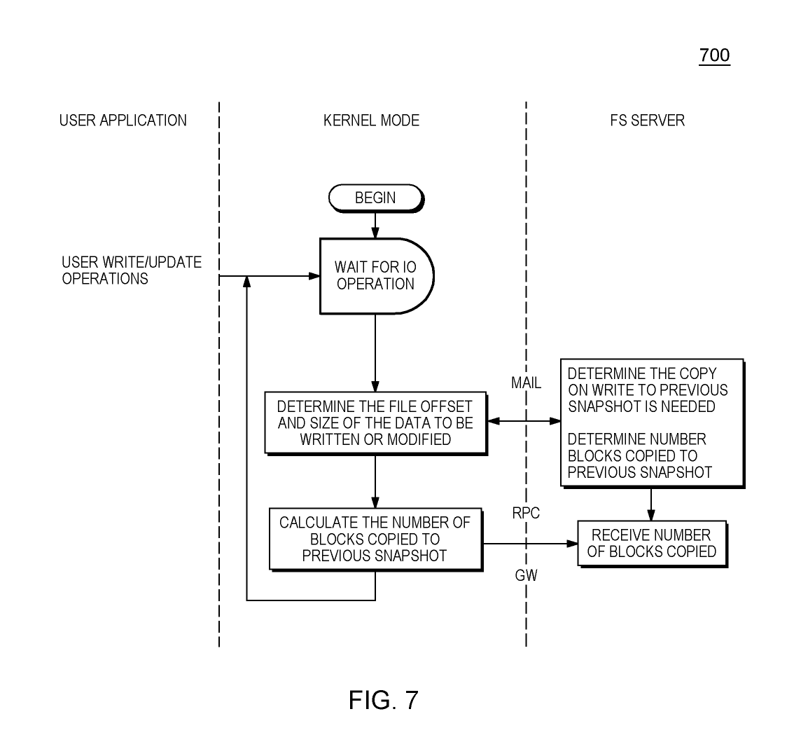

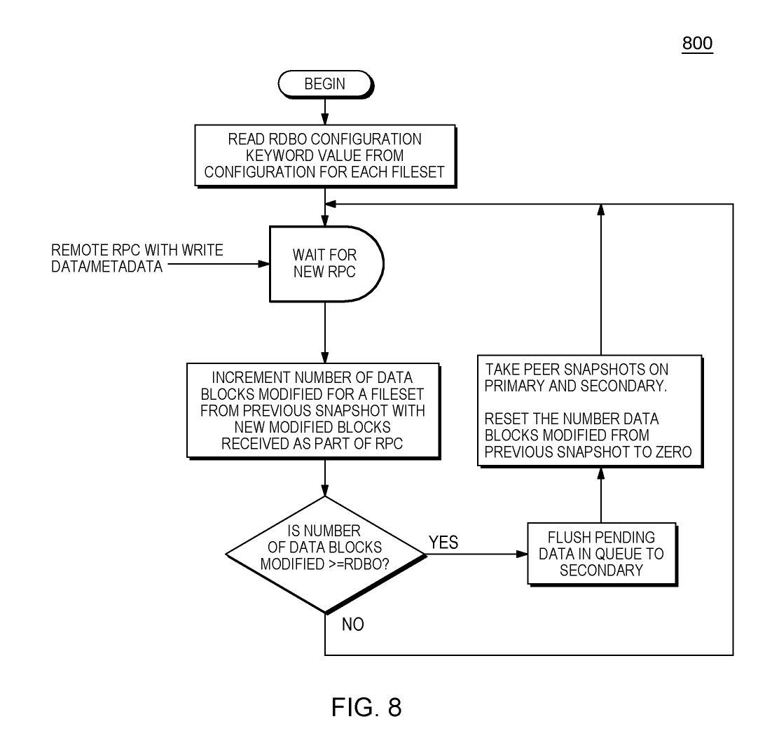

It will now be described how the RDBO specification is used to take peer snapshots based on data and metadata blocks modified for consistent RTO in some embodiments: (i) the user applications could do IO (input/output) updates continuously by sending IO requests to kernel VFS (virtual file system); (ii) the file system (like Spectrum Scale) kernel module would initiates and executes the IO updates; (iii) while updating the files, it would request copying the original (before modification) data blocks to previous snapshot, called copy-on-write by sending request to File Server; (iv) the copy-on-write is enhanced to return to kernel the number of blocks copied to previous snapshot; (v) the kernel File System module passes the number blocks copied to DR gateway node as part of data update operation request through RPC (Remote Procedure Call) call as described in diagram 700 of FIG. 7; (vi) there will be a dedicated Gateway node for each fileset running on primary site; (vii) a single Gateway node can support multiple filesets for replicating modified data for those filesets from Primary to Secondary asynchronously and continuously as the data gets modified; (viii) the gateway node is also running a RDBO Snapshot Manager, which reads the Recovery Data Block Objective defined as configuration parameter; (ix) it monitors the number of data blocks modified from most recent peer snapshot; and (x) as described in flow chart 800 of FIG. 8, for any fileset at any time, the number of data blocks, which are copied to most recent snapshot is accumulated and compared against RDBO configured.

Further to item (x) in the list of the preceding paragraph, in some embodiments, if the number of all the modified blocks exceeds the RDBO limit specified, then synchronized peer snapshots are taken both on Primary and Secondary sites to ensure that the data blocks modified at any time would not be more than the RDBO defined.

An embodiment of the present invention (called the RPO/RDO/RDBO embodiment) that uses all of the RPO parameter, the RDO parameter and the RDBO parameter to control backup of data to secondary site(s) (or secondary cluster(s) will now be discussed in the following paragraphs. The new DR specifications RDO and RDBO can be used in combination with standard specification RPO for getting the advantage of these specifications.

The following are potential advantages and limitations of the RPO parameter aspect of the RPO/RDO/RDBO embodiment: (i) the use of the RPO parameter does not enforce the maximum data lost accurately if disaster hits Primary; (ii) the RTO can't be estimated accurately based on RPO; and (iii) because snapshots are taken regularly there would not be any indefinite delay in taking snapshots if only small amount of data is modified.

The following are potential advantages and limitations of the RDO parameter aspect of the RPO/RDO/RDBO embodiment: (i) the maximum data that can be lost if disaster hits Primary can be defined; (ii) the RTO may be proportional to data RDO defined but not accurately because data changes may not be contiguous and may not be multiple of data block size; (iii) sometimes, especially if data changes to file system are done occasionally, the peer snapshot may be delayed for long time since the most recent changes does not meet RDO specified and no more changes are happening; and (iv) this will increase the chance of losing some data if disaster hits Primary.

The following are potential advantages and limitations of the RDBO parameter aspect of the RPO/RDO/RDBO embodiment: (i) the maximum real data that can be lost if disaster hits Primary can't be defined accurately; (ii) the maximum data that can be lost would be number of blocks multiplied by the data block size; (iii) this will be higher than the actual data lost since data modified are not contiguous and may not be multiple of data block size; (iv) the RTO is proportional to the RDBO because all the modified blocks need to be restored; and (v) like RDO, this can cause significant delay in taking peer snapshots and increasing the chance to lose some data if disaster hits Primary.

In the RPO/RDO/RDBO embodiment, all of these three DR specifications or any combination of them can be defined together for getting collective advantages of the specifications. For example, if all three specifications are defined then whenever any DR specification meets the condition, the RPO/RDO/RDBO embodiment does the following and/or achieves the following collective advantages: (i) the peer snapshots are taken both on Primary and Secondary; and (ii) all the DR specification monitoring parameters are reset to zero so that all three parameters are monitored for determining when to take next peer snapshot.

Some embodiments of the present invention may include one, or more, of the features, advantages, operations and/or characteristics set forth in the following enumerated paragraphs.

1. The Recovery Data Objective defines a new parameter to take snapshots based on size of data modified/updated/added from previous snapshot.

2. The RDO defines upper bound of the data that can be lost when disaster happen.

3. Most likely the RTO is proportional to the RDO defined if the data modified, or added is contiguous, which helps to estimate the RTO based on RDO configured.

4. The RDO and RPO both can be configured to avoid potential loss of the data when some relatively small changes are done initial after taking snapshot and no changes are done for a long time.

5. The moving average of data generated by applications and the Bandwidth of data replication to Secondary can be used to predict the next RDO snapshot and plan for taking peer snapshots as soon as RDO is meet without any lag in tine or data.

6. Even though the new files created from previous snapshot are not restored from previous snapshot the sizes of the new files also considered for RDO since that would accounted the data to be lost when disaster happened.

7. The number data blocks modified excluding the data blocks added, are used to take peer snapshots when the blocks modified are meet the RDBO (Recovery Data Block Objective).

8. The RTO is proportional to the RDBO defined since all the modified data blocks need to be restored as part of recovery. The RTO can be accurately estimated based on RDBO.

9. Estimation of RTO consistently, helps to properly plan for Disaster Recovery.

10. Multiple modifications to same data blocks are ignored since restore will be done once for single update or for multiple updates of a data block.

11. The File System,s Copy_On_Write feature is enhanced to determine the data blocks modified. This is more efficient method since Copy_On_Write already implemented as part of data updates by File Systems and no additional cost is involved in determining the data blocks modified.

12. By using the Copy_On_Write, it would be automatically ensured that the multiple modifications to same data block is ignored and only first update is taken into consideration.

13. The metadata changes to the file also taken into considerations for data block changes.

14. The RPO specification can be used along with RDO specification to avoid the delay in taking the peer snapshot if the most recent changes do not meet RDO specified and no more changes are happening for long time. This will increase the chance of losing some data if only RDO is used.

15. The RPO specification can be used along with RDBO specification to avoid the delay in taking the peer snapshot if the most recent changes do not meet RDBO specified and no more changes are happening for long time. This will increase the chance of losing some data if only RDBO is used.

16. The RDO specification and RDBO specification both can be used to ensure that maximum data that can be lost is RDO and the maximum number of data blocks modified not more than RDBO, if disaster hits the Primary.

17. If both RDO and RDBO along with RPO are specified, then: a. The data loss can be accurately determined; b. The RTO can be accurately estimated; c. The peer snapshots are taken once at least for RPO interval if data is modified.

18. Taking snapshots based on amount (that is, volume) of the data modified.

19. Taking snapshots based on number of data blocks modified.

20. Taking snapshots based on number of data blocks modified, and combining it with data value modified.

Some embodiments of the present invention may include one, or more, of the following characteristics, features, advantages and/or operations: (i) provide a method or system for taking snapshots based on size of data modified or added from previous snapshot using recovery data objective (RDO) and recovery data block objective (RDBO) parameters for disaster recovery; (ii) RDO and RDBO define a maximum data updated or modified that can be lost during disaster and a maximum data obtained by multiplying number of blocks by data size that can lost if disaster hits primary site, respectively; (iii) taking the peer snapshots based on data modified or added (RDO) from previous snapshot on clustered filesystem; (iv) the size (data size of write) of data modified is accumulated on data replication (Gateway) node as data gets modified or added; and/or (v) the data replication to DR site is done close to real time without any lag so that peer snapshots are taken as soon as data modified or added exceeds the threshold RDO (Recovery Data Objective) value defined.

Some embodiments of the present invention may include one, or more, of the following characteristics, features, advantages and/or operations: (i) the peer snapshots also taken based on data blocks are modified only from previous snapshots; (ii) the new data blocks added are not considered as data blocks modified, since the new data blocks are not required to be restored when failover to DR site; (iii) the modified data blocks are calculated as the data blocks are modified exploiting the copy-on-write mechanism of file system; (iv) there is no additional over head to calculate the number data blocks modified; (v) the number of data blocks modified are accumulated at the Gateway node and compared against pre-defined threshold RDBO (Recovery Data Blocks Objective) value to take peer snapshots; (vi) if the peer snapshots are taken based on data blocks modified, the RTO would be consistent always because RTO is proportional to the number of data blocks modified from previous snapshot, which would be restored when failover to DR site; and/or (vii) the RDO and RDBO can be used in combination so that the peer snapshots are taken when either of these objectives are met to provide limit on the maximum data to be lost during disaster and at the same time ensuring the consistent RTO.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
setting a recovery data objective (RDO) threshold value;
operating a data recovery (DR) system including a first data storage sub-system and a second data storage sub-system, where: (i) the second data storage sub-system is located remotely from the first data storage sub-system, and (ii) data from the first data storage sub-system is replicated to the second data storage sub-system;
during the operation of the DR system, determining that the RDO threshold value has been met; and
responsive to the determination that the RDO threshold has been met, performing local backups at the first and second data storage sub-systems.

2. The method of claim 1 wherein the performance of local backups includes synchronized snapshotting.

3. The method of claim 1 further comprising:
recovering from a disaster that destroys the first data storage sub-system using data stored in the second data storage sub-system.

4. The method of claim 1 wherein:
the first data storage sub-system includes a primary cluster, a plurality of input/output nodes and a plurality of compute nodes; and
the second data storage sub-system includes a secondary cluster, a plurality of input/output nodes and a plurality of compute nodes.

5. The method of claim 1 further comprising:
setting a recovery data block objective (RDBO) threshold value;
during the operation of the DR system, determining that the RDBO threshold value has been met; and
responsive to the determination that the RDBO threshold has been met, performing local backups at the first and second data storage sub-systems.

6. The method of claim 1 further comprising:
setting a recovery point objective (RPO) threshold value;
during the operation of the DR system, determining that the RPO threshold value has been met; and
responsive to the determination that the RPO threshold has been met, performing local backups at the first and second data storage sub-systems.

7. The method of claim 6 further comprising:
setting a recovery data block objective (RDBO) threshold value;
during the operation of the DR system, determining that the RDBO threshold value has been met; and
responsive to the determination that the RDBO threshold has been met, performing local backups at the first and second data storage sub-systems.

8. A computer-implemented method comprising:
setting a recovery data block objective (RDBO) threshold value;
operating a data recovery (DR) system including a first data storage sub-system and a second data storage sub-system, where: (i) the second data storage sub-system is located remotely from the first data storage sub-system, and (ii) data from the first data storage sub-system is replicated to the second data storage sub-system;
during the operation of the DR system, determining that the RDBO threshold value has been met; and
responsive to the determination that the RDBO threshold has been met, performing local backups at the first and second data storage sub-systems.

9. The method of claim 8 wherein the performance of local backups includes synchronized snapshotting.

10. The method of claim 8 further comprising:
recovering from a disaster that destroys the first data storage sub-system using data stored in the second data storage sub-system.

11. The method of claim 8 wherein:
the first data storage sub-system includes a primary cluster, a plurality of input/output nodes and a plurality of compute nodes; and
the second data storage sub-system includes a secondary cluster, a plurality of input/output nodes and a plurality of compute nodes.

12. The method of claim 8 further comprising:
setting a recovery point objective (RPO) threshold value;
during the operation of the DR system, determining that the RPO threshold value has been met; and
responsive to the determination that the RPO threshold has been met, performing local backups at the first and second data storage sub-systems.

13. The method of claim 12 further comprising:
setting a recovery data block objective (RDBO) threshold value;
during the operation of the DR system, determining that the RDBO threshold value has been met; and
responsive to the determination that the RDBO threshold has been met, performing local backups at the first and second data storage sub-systems.

14. The method of claim 8 further comprising:
determining, by a copy on write feature of a file system, a number of data blocks modified.

15. The method of claim 14 wherein the determination of the number of data blocks modified ensures that the multiple modifications to any given data block is ignored such that only a first-in-time update is taken into consideration.

16. A computer-implemented method comprising:
setting a recovery data objective (RDO) threshold value;
setting a recovery data block objective (RDBO) threshold value;
setting a recovery point objective (RPO) threshold value;
operating a data recovery (DR) system including a first data storage sub-system and a second data storage sub-system, where: (i) the second data storage sub-system is located remotely from the first data storage sub-system, and (ii) data from the first data storage sub-system is replicated to the second data storage sub-system;
during the operation of the DR system, determining that the RDO threshold value has been met;
responsive to the determination that the RDO threshold has been met, performing local backups at the first and second data storage sub-systems;
during the operation of the DR system, determining that the RPO threshold value has been met;
responsive to the determination that the RPO threshold has been met, performing local backups at the first and second data storage sub-systems;
during the operation of the DR system, determining that the RDBO threshold value has been met; and
responsive to the determination that the RDBO threshold has been met, performing local backups at the first and second data storage sub-systems.

17. The method of claim 16 wherein the performance of local backups includes synchronized snapshotting.

18. The method of claim 16 further comprising:
recovering from a disaster that destroys the first data storage sub-system using data stored in the second data storage sub-system.

19. The method of claim 16 wherein:
the first data storage sub-system includes a primary cluster, a plurality of input/output nodes and a plurality of compute nodes; and
the second data storage sub-system includes a secondary cluster, a plurality of input/output nodes and a plurality of compute nodes.
